(19) United States
(12) Patent Application Publication
(10) Pub. No.: US 2004/0254966 A1
(43) Pub. Date: Dec. 16, 2004

(54) Bit manipulation operation circuit and method in programmable processor

(75) Inventors: Myunghoon Sunwoo, Seoul (KR); Seokhyun Jeong, Daegu-city (KR)

Correspondence Address: MERCHANT & GOULD PC, P.O. BOX 2903, MINNEAPOLIS, MN, 55402-0903, US

(73) Assignee: DAEWOO EDUCATIONAL FOUNDATION, Kyeonggi-do (KR)

(21) Appl. No.: 10/845,784

(22) Filed: May 12, 2004

(30) Foreign Application Priority Data
May 16, 2003 (KR) 10-2003-31181

(51) Int. Cl. G06F 7/00

(52) U.S. Cl. 708/200

(57) ABSTRACT

A bit manipulation circuit which can speedily carry out unit operations, such as repetitive data shifts and modulo-2 additions, and bit extraction and insertion, so as to facilitate the operation of a communication system involved with such unit operations while maintaining simple hardware complexity. The bit manipulation circuit is suitable for use in a programmable processor comprising a register bank for temporarily storing an operand data and performs data encoding operation based data shift modulo-2 addition, and bit extraction and insertion operation. In the circuit, a shift addition array receives the operand data, generates a plurality of shifted data being shifted from the operand data by one bit through the bit width of the operand data, carries out Mod-2 additions in parallel with respect to the operand data and at least some of the plurality of shifted data, and stores the addition result in the register bank. A bit extraction and insertion unit receives the operand data, extracts a plurality of bits from the operand data, and inserts each of the extracted bits into a predetermined bit position of an operated data to store the operated data to the register bank.

### BACKGROUND OF THE INVENTION

1. Field of the Invention

The present invention relates to a digital signal processor and an operation method in the same and, more particularly, an operation circuit and method in a programmable processor.

2. Description of Related Arts

Digital communication systems have similar functional blocks such as blocks for performing bit manipulation operations of scrambling/descrambling, convolutional encoding, puncturing, and interleaving/deinterleaving. Such bit manipulations are generally have been implemented using a dedicated hardware rather than a programmable processor because the operations have different characteristics depending on communication standards and the word length may be incompatible with that of the programmable processor. However, in light of the improvements of the programmable processors and the needs for the flexibility of accommodating various standards, much endeavors are made to implement the bit manipulations using the programmable processors. Thus, the signal processing in programmable processors is researched as a core technology for the future communications system, Software Defined Radio (SDR).

Among the bit manipulations mentioned above, scrambling/descrambling and convolutional encoding are characterized by a constraint length, a code rate, and a generator polynomial, and are implemented using a shift register and exclusive-OR (X—OR) gates. The constraint length is denoted by K=M+1, where M is the number of memory elements in the shift register. The code rate is the ratio of the number of coded bits to input bits. The generator polynomial which represents the positions of X—OR gates is expressed by a following equation 1, in which the term of each order represents the existence of a X—OR gate in a corresponding position of the register.

g(x)=x^{K-1}+x^{K-2}+x^{K-3}+ . . . +x²+x+1 (1)

During an encoding process, data bits are serially shifted in response to clock signals and undergo modulo-2 addition, and then the operation result is fed back or outputted. Thus, scrambling/descrambling and convolutional encoding commonly involve modulo-2 addition of shifted data.

Meanwhile, the puncturing is an operation of deleting some of the input bits, in which the deleting pattern is determined according to the code rate. The interleaving and de-interleaving are operations of shuffling data bits and is characterized by the size of the interleaver and de-interleaver and the interleaving scheme. Although the operations have regular patterns, it is not easy to implement an architecture which can accommodate different characteristics of a variety of communication standards. Nevertheless, it can be said that the bit insertion and the bit extraction in arbitrary bit positions are the common operations of the puncturing and the interleaving and de-interleaving.

As mentioned above, the common basic operations of the bit manipulations include repetitive bit shifting, modulo-2 addition, and the bit insertion/extraction operation. FIG. 1 shows a block diagram of a computation unit of a general digital signal processor (DSP) and operation flows for carrying out the bit shifting, modulo-2 addition, and the bit insertion/extraction operations. In FIG. 1, the data computation unit is composed of an arithmetic operation unit 11, a logical operation unit 12, and a shifter 13. In the data computation unit, repetitive data shift and modulo-2 addition can be performed by repetitively carrying out a step of reading data from the register file or register bank 14 and shifting the data in the shifter (step 31), and a step of performing modulo-2 addition in the logical operation unit 12 (step 32). Meanwhile, the bit extraction operation is performed by shifting data alternately (left-to-right, right-to-left), as shown by step 41, to extract consecutive bits in an arbitrary position. In addition, the bit insert operation can be performed by combining the shift operation logic AND or OR operations in the logical operation unit 12. However, such a data computation unit is not provided with any scheme for supporting repetitive and fast modulo-2 additions of plurality of shifted data each being shifted by different shift amount.

FIGS. 2A through 2C show examples of bit insertion and extraction operations of performed by commercial DSP's based on the manuals provided by the vendors. FIG. 2A shows the operation of a Starcore 140 (SC140) provided by Starcore LLC, which supports an operation of receiving width and offset information to extract consecutive bits, and an operation of inserting consecutive bits. FIG. 2A shows the operation of a TI S6x platform provided by Texas Instruments Incorporated, which supports an operation of receiving offset information to extract consecutive bits, and fixed operations of shuffling two input words and deshuffling shuffled words. The platforms of FIGS. 2A and 2B perform the bit insertion and extraction operations by carrying out basic shift operations. Also, the platforms, which have VLIW (Very Long Instruction Word) architecture, can reveal enhanced performance by simultaneously using a plurality of data computation units. Meanwhile, TI 5x platform shown in FIG. 2C supports a bit extraction operation of extracting bits, among consecutive input bits, in bit positions where the corresponding bits of a mask are set to a specific state while pading zeroes between the extracted bits. In FIG. 2C, the bit insertion operation is performed by consecutively outputting input data bits where the corresponding bits of the mask are set to the specific state. Here, “Starcore”, “SC140”, and “Starcore LLC” are trademarks of Starcore LLC, and “TI” and “Texas Instruments” are trademarks of Texas Instruments Incorporated.

Even though the conventional DSPs can carry out the bit insertion or extraction operation according to specific rules, they seem to show limitation in the versatility of the bit insertion and extraction operations and cannot arbitrarily extract plural bits dispersed or contiguous in the input data nor arbitrarily insert plural bits into bit positions dispersed or contiguous in the output data, and thus cannot supports various communication standards. Further, according to the prior arts, lots of clock cycles are required in the puncturing or the interleaving operation, because data bits are extracted from plural input data words and then the extracted bits should be combined into a single output word using logic OR operations. Because of the aforementioned problems, the operation efficiency is reduced in performing the mixing of various output data convolutionally encoded, puncturing, interleaving, or de-interleaving operation.

### SUMMARY OF THE INVENTION

To solve the above problems, one object of the present invention is to provide a bit manipulation circuit which can speedily carry out unit operations, such as repetitive data shifts and modulo-2 additions, and bit extraction and insertion, so as to increase the operation speed of a communication system involved with such unit operations while maintaining simple hardware complexity.

Another object of the present invention is to provide a programmable processor employing the bit manipulation circuit.

Yet another object of the present invention is to provide methods for easily performing bit manipulation operations such as scrambling, convolutional encoding, and puncturing, using the bit manipulation circuit.

According to an aspect of the bit manipulation circuit for achieving one of the above objects, the circuit is suitable for use in a programmable processor comprising a register bank for temporarily storing an operand data and performs data encoding operation based on data shift modulo-2(Mod-2) addition, and bit extraction and insertion operation. In the bit manipulation circuit, a shift addition array receives the operand data, generates a plurality of shifted data being shifted from the operand data by one bit through the bit width of the operand data, carries out Mod-2 additions in parallel with respect to the operand data and at least some of the plurality of shifted data, and stores the addition result in the register bank. A bit extraction and insertion unit receives the operand data, extracts a plurality of bits from the operand data, and inserts each of the extracted bits into a predetermined bit position of an operated data to store the operated data in the register bank.

Preferably, the register bank includes a bit-loadable register capable of loading data bit by bit. The bit extraction and insertion unit receives the operand data from the bit-loadable register and provides the operated data to the bit-loadable register, and the bit-loadable register loads the operated data only in the predetermined bit positions.

In a preferred embodiment, the bit extraction and insertion unit is comprised of a bit extraction unit and a bit insertion unit. The bit extraction unit receives a first mask having a bit width being the same as the operand data, and extracts only the operand data bits in the bit positions where the corresponding bit in the first mask is set to a first state. The bit insertion unit receives a second mask having a bit width being the same as the operated data, and inserts the extracted bits into the operated data bits in the bit positions where the corresponding bit in the second mask is set to the first state. The bit-loadable register loads the operated data only in the bit positions where the corresponding bit in the second mask is set to the first state.

Preferably, the shift addition array is comprised of a plurality of gated addition rows cascadingly connected one after the other. Each of the gated addition rows receives a first and a second data, carries out Mod-2 additions of the first and the second data when a corresponding bit in the first mask is set to the first state, but outputs the first data when the corresponding bit in the first mask is set to the second state. In a first gated addition row, the first data is the operand data and the second data is one-bit shifted operand data. In another gated addition row, e.g., a j-th gated addition row where j is greater than or equal to two, the first data is the output data of the (j−1)-th gated addition row and the second data is (j+1)-bit shifted operand data. In a preferred embodiment, the bit manipulation circuit further includes a first switching unit for reading the operand data from the register bank to provide to the shift addition array; and a second switching unit for storing the output data of the gated addition rows to the register bank. It is preferable that the second switching unit stores the output data of each of the gated addition rows to the register bank only when the corresponding bit in the first mask is set to the first state.

According to another aspect of the present invention, for achieving one of the above objects, a bit extraction and insertion circuit includes a bit-loadable register and a bit extraction and insertion unit. The bit-loadable register receives a first mask and loads a received data word bit by bit according to a bit setting status of the first mask. The bit extraction and insertion unit, receiving the first mask, a second mask, and the data word, extracts a plurality of bits from the data word according to a bit setting status of the second mask, and inserts each of the extracted bit into a predetermined bit position of an operated data according to the bit setting status of the first mask to output the operated data to the bit-loadable register. The bit-loadable register loads the operated data bit by bit according to the bit setting status of the first mask.

A programmable processor for achieving another one of the above objects includes a bit extraction and insertion unit for facilitating bit manipulation operations in addition to a register bank for temporarily storing an operand data and a computation unit for performing arithmetic and logic operations. The computation unit receives the operand data, performs arithmetic and logic operations with respect to the operand data, and stores the operation result to the register bank. The bit extraction and insertion unit receives the operand data, extracts a plurality of bits in bit positions of the operand data specified by a first mask, and inserts each of the extracted bits into a bit position of an operated data specified by a second mask to output the operated data to the register bank. Also, another unit for generating the first and the second masks is preferably incorporated additionally to the processor.

According to an aspect of the bit manipulation method for achieving yet another one of the above objects, the method is suitable for carrying out scrambling operation. First, a mask having a predetermined number of bits is provided. Then, a predetermined number of shifted data words being shifted from the data word by one bit through the predetermined number of bits are generated, and Mod-2 additions are sequentially carried out with respect to the data word and at least some of the shifted data words specified by the mask. Each of the sequentially generated addition results is separately stored in respective register in the register bank.

According to another aspect of the bit manipulation method of the present invention, the method is suitable for carrying out convolutional encoding operation. First, a mask having a predetermined number of bits is provided. Then, two data words stored in the register bank are read and concatenated to generate a concatenated word. Afterwards, a predetermined number of shifted words being shifted by one bit through the predetermined number of bits are generated from the concatenated word, and Mod-2 additions are carried out with respect to the concatenated word and at least some of the shifted words specified by the mask. Finally, at least a partial bit stream of the addition result is stored in the register bank.

According to yet another aspect of the bit manipulation method of the present invention, the method is suitable for carrying out puncturing operation. First, a first and a second masks and a bit-loadable register capable of loading data word bit by bit are provided. After the data word is loaded in the bit-loadable register, at least some bits of the data word are extracted according to a bit setting status of the first mask. An operated data word is generated by inserting the extracted bits into predetermined bit positions of the operated data word according to a bit setting status of the second mask. Finally, only the bits in the operated data word specified by the second mask are loaded into the bit-loadable register.

### BRIEF DESCRIPTION OF THE DRAWINGS

The above objectives and advantages of the present invention will become more apparent by describing in detail preferred embodiments thereof with reference to the attached drawings, in which:

FIG. 1 is a block diagram showing related art computation units of a general DSP and procedure of a bit manipulation;

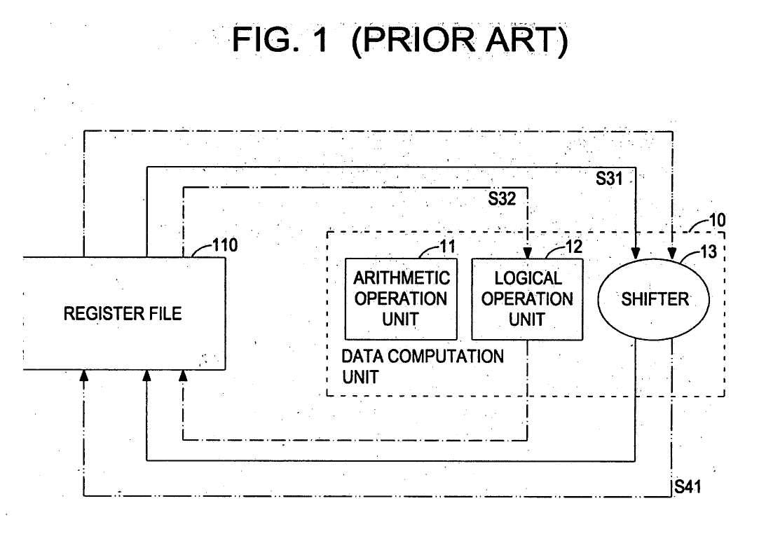

FIGS. 2A through 2C show examples of bit insertion and extraction operations performed by conventional digital signal processors;

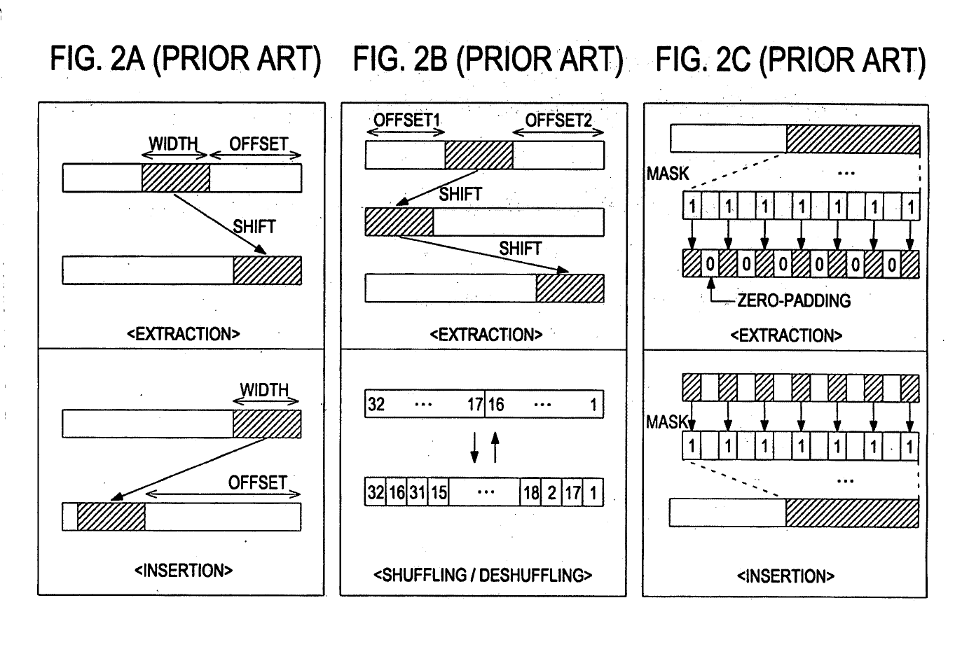

FIG. 3 is a block diagram of a digital signal processor according to a preferred embodiment of the present invention;

FIG. 4 is a logic diagram of an embodiment of the shift addition array shown in FIG. 3;

FIG. 5 is a logic diagram of an embodiment of the bit extraction and insertion unit shown in FIG. 3;

FIGS. 6A and 6B are logic diagrams of the circuits for generating the selection signals shown in FIG. 5;

FIG. 7 illustrates the operation of the bit extraction and insertion unit of FIG. 5; and

FIG. 8 illustrates an embodiment of the bit-loadable register shown in FIG. 3.

### DETAILED DESCRIPTION OF PREFERRED EMBODIMENTS

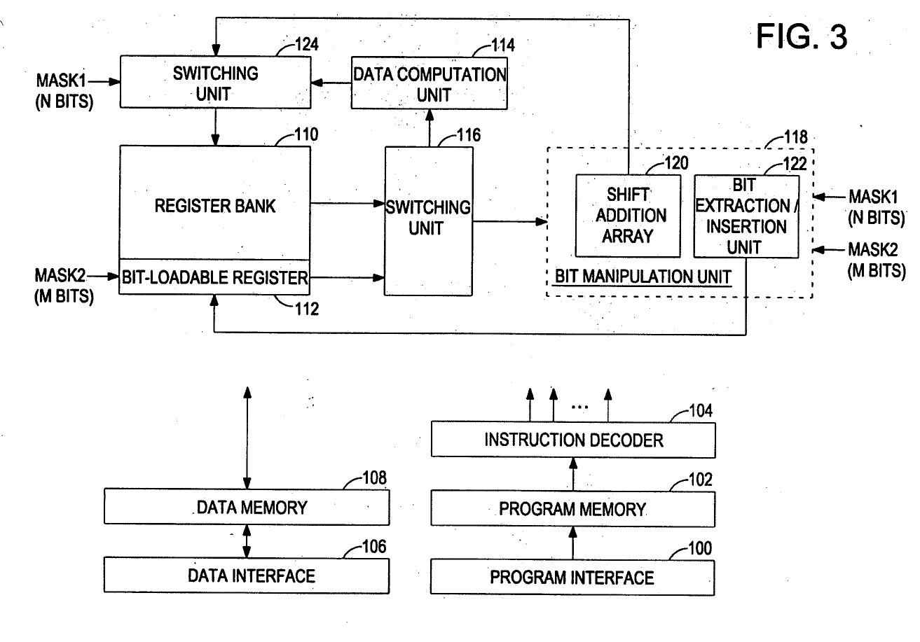

Referring to FIG. 3, a digital signal processor according to an embodiment of the present invention includes a program interface 100, a program memory 102, an instruction decoder 104, a data interface 106, a data memory 108, a register file or register bank 110, a bit-loadable register 112, a data computation unit 114, switching units 116 and 124, and a bit manipulation unit 118. Also, the bit manipulation unit 118 includes a shift addition array 120 and a bit extraction and insertion unit 122.

The program interface 100 receives a program formed of a sequence of instructions from an external device to store in the program memory 102. The instruction decoder 104 decodes the instructions from the program memory 102 to sequentially output control signals corresponding to the instructions to the register bank 110, the bit-loadable register 112, the data computation unit 114, the switching units 116 and 124, or the bit manipulation unit 118, so that the arithmetic or logic operations are carried out according to the control signals.

The data interface 106 receives operand data and mask data described below from the external device or the instruction decoder 104 to store in the data memory 108. The data in the data memory 108 go through the arithmetic or logic operations by the data computation unit 114 or the bit manipulation unit 118 while temporarily being stored in the register bank 110 or the bit-loadable register 112, and operation results are written into the data memory 108 again.

The register bank 110 and the bit-loadable register 112 temporarily store the operand data and the mask data, and the operation result data from the data computation unit 114 or the bit manipulation unit 118. The bit-loadable register 112 is similar to one of the multiple registers in the register bank 110, but has a function of receiving a mask MASK2 and loading input data only for the bit positions instructed by the mask MASK2.

The data computation unit 114 includes the arithmetic and logic operation units and the shifter similar to those of a conventional digital signal processor, and thus can carries out arithmetic and logic operations and shifting similarly to the conventional digital signal processor. In other words, in a preferred embodiment, the digital signal processor according to the present invention further includes a bit manipulation unit 118 for carrying out certain bit manipulation operations while maintaining the conventional data computation unit. Whether a bit manipulation for the data stored in the register bank 110 is carried out by the data computation unit 114 or the bit manipulation unit 118 is determined by the control signals from the instruction decoder 104.

The switching unit 116 selects one of output data from the registers of the register bank 110 and the bit-loadable register 112 and provides the selected data to the bit manipulation unit 118. The switching unit 124 stores output data, selected by the mask MASK1, from the bit manipulation unit 118 into one or more of the registers of the register bank 110 and the bit-loadable register 112 selected by the control signals. Such switching units 116 and 124 can be implemented using a plurality of multiplexers, and their switching operations are determined by the control signals from the instruction decoder 104. Meanwhile, the bit-loadable register 112 is directly coupled to the bit manipulation unit 118, so as to receive data from the bit manipulation unit 118 only for the bit positions instructed by the mask MASK2.

The bit manipulation unit 118 carries out bit manipulations with respect to the data received via the switching unit 116. In the bit manipulation unit 118, the shift addition array 120 performs Mod-2 additions, in parallel, with respect to M bits wide input data and all or some of N-tuple M bits wide shifted data respectively shifted by one through N bits, and provides N-tuple M bits wide output data to the switching unit 124. The switching unit 124 stores, in the register bank 110 or the bit-loadable register 112, all or some of the N-tuple output data according to the bit setting status of the mask MASK1.

The bit extraction and insertion unit 122 extracts some bits in a N bits wide input data according to the bit setting status of the mask MASK1 and inserts the extracted bits to the bit positions instructed by the bit setting status of the mask MASK2. As described below in more detail, the bit extraction and insertion unit 122 can arbitrarily extract a plurality of bits dispersed or contiguous in the N bits wide input data and outputs the extracted bits to arbitrary bit positions in the output data. Preferably, the output data manipulated by the bit extraction and insertion unit 122 is stored in the bit-loadable register 114.

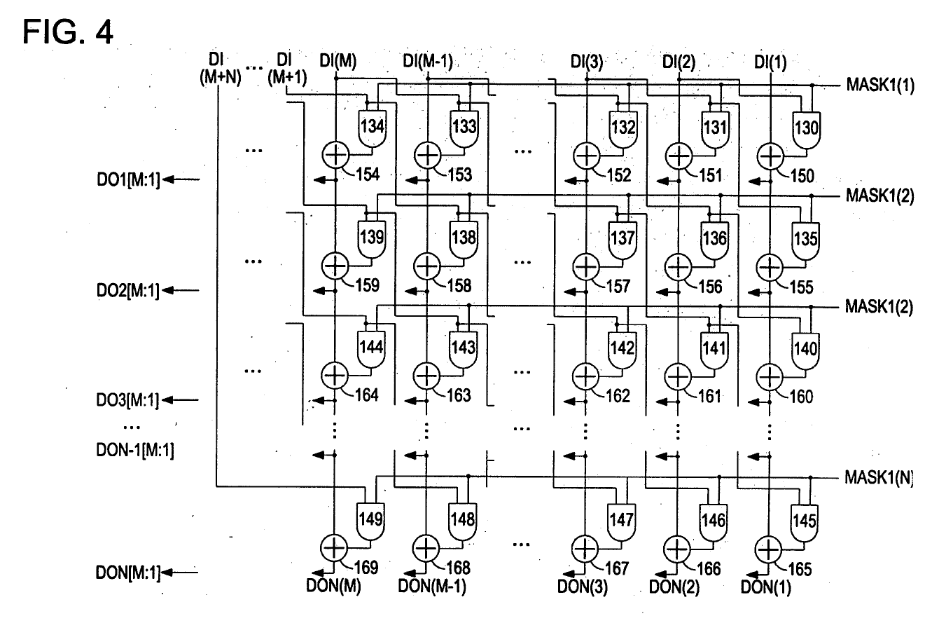

FIG. 4 shows an embodiment of the shift addition array 120 shown in FIG.3 in detail. In this embodiment, the shift addition array 120 includes M*N AND gates 130 through 149 and M*N modulo-2 adders 150 through 169 which can be implemented using exclusive-OR gates. N gated addition rows are disposed in FIG. 4, and each gated addition row includes M gated addition cells each of which gates a shifted input data bit and performs Mod-2 addition with respect to the gated shift data and another input data bit. The shift addition array 120 receives input data DI of maximum M*N bits and the mask MASK1, shifts the input data DI by one through N bits to generate N-tuple M bits wide shifted input data, and performs Mod-2 additions, in parallel, with respect to the input data DI and at least some of the N-tuple M bits wide shifted input data selected by the mask MASK1 to output N-tuple M bits wide output data DO1 through DON.

In a first gated addition row comprising of the AND gates 130 through 134 and the adders 150 through 154, each of the AND gates 130 through 134 receives a data bit in a corresponding bit position of the 1-bit shifted input data DI[M+1:2] through a first input terminal and a first bit MASK1(1) of the mask MASK1 though a second input terminal to perform the logic AND operation. Thus, the AND gates 130 through 134 allows the shifted input data DI[M+1:2] to the adders 150 through 154 only when the first bit MASK1(1) of the mask MASK1 is set to “1”, while outputting “0” when the first bit MASK1(1) of the mask MASK1 is set to “0”. Each of the adders 150 through 154 receives a data bit in a corresponding bit position of the input data DI[M:1] through one input terminal and the output of respective AND gate through another input terminal to perform Mod-2 addition. The adders 150 through 154 may output the addition results as a first output data DO1[M:1] of the shift addition array 120. As a result, the first output data DO1[M:1] is Mod-2 addition of the input data DI[M:1] and the 1-bit shifted input data DI[M+1:2] in case that the bit MASK1(1) is set to “1”, but is the same as the input data DI[M:1] in case that the bit MASK1(1) is set to “0”.

In a second gated addition row comprising the AND gates 135 through 139 and the adders 155 through 159, first input terminals of the AND gates 135 through 138 are coupled to the first input terminals of the AND gates 131 through 134 in the first gated addition row, respectively, and first input terminal of the AND gate 139 is coupled to the receiving terminal of the input data bit DI(M+2). Thus, each of the AND gates 135 through 139 receives a data bit in a corresponding bit position of the 2-bit shifted input data DI[M+2:3] through the first input terminal and a second bit MASK1(2) of the mask MASK1 though a second input terminal to perform the logic AND operation. Accordingly, the AND gates 135 through 139 allows the shifted input data DI[M+2:3] to the adders 155 through 159 only when the second bit MASK1(2) of the mask MASK1 is set to “1”, while outputting “0” when bit MASK1(2) is set to “0”. Each of the adders 155 through 159 receives a data bit in a corresponding bit position of the first output data DO1[M:1] through one input terminal and the output of respective AND gate through another input terminal to perform Mod-2 addition. The adders 155 through 159 may output the addition results as a second output data DO2[M:1] of the shift addition array 120. As a result, the second output data DO2[M:1] is Mod-2 addition of the first output data DO1[M:1] and the 2-bit shifted input data DI[M+2:3] in case that the bit MASK1(2) is set to “1”, but is the same as the first output data DO1[M:1] in case that the bit MASK1(2) is set to “0”. That is, the second output data DO2[M:1] is Mod-2 addition of the input data DI[M:1] and the data selected by the mask data MASK1[2:1] of the shifted data DI[M+1:2] and DI[M+2:3].

In a third gated addition row comprising of the AND gates 140 through 144 and the adders 160 through 164, first input terminals of the AND gates 140 through 143 are coupled to the first input terminals of the AND gates 136 through 139 in the second gated addition row, respectively, and first input terminal of the AND gate 144 is coupled to the receiving terminal of the input data bit DI(M+3). Thus, each of the AND gates 140 through 144 receives a data bit in a corresponding bit position of the 3-bit shifted input data DI[M+3:4] through the first input terminal and a third bit MASK1(3) of the mask MASK1 though a second input terminal to perform the logic AND operation. Accordingly, the AND gates 140 through 144 allows the shifted input data DI[M+3:4] to the adders 160 through 164 only when the third bit MASK1(3) of the mask MASK1 is set to “1”, while outputting “0” when bit MASK1(3) is set to “0”. Each of the adders 160 through 164 receives a data bit in a corresponding bit position of the second output data DO2[M:1] through one input terminal and the output of respective AND gate through another input terminal to perform Mod-2 addition. The adders 160 through 164 may output the addition results as a third output data D03[M:1] of the shift addition array 120. As a result, the third output data D03[M:1] is Mod-2 addition of the second output data DO2[M:1] and the 3-bit shifted input data DI[M+3:4] in case that the bit MASK1(3) is set to “1”, but is the same as the second output data DO2[M:1] in case that the bit MASK1(3) is set to “0”. That is, the third output data D03[M:1] is Mod-2 addition of the input data DI[M:1] and the data selected by the mask data MASK1[3:1] among the shifted data DI[M+1:2], DI[M+2:3], and DI[M+3:4].

Similarly, in a N-th gated addition row comprising the AND gates 145 through 149 and the adders 165 through 169, first input terminals of the AND gates 145 through 148 are coupled to the first input terminals of the AND gates in the (N−1)-th gated addition row, respectively, and first input terminal of the AND gate 149 is coupled to the receiving terminal of the input data bit DI(M+N). Thus, each of the AND gates 145 through 149 receives a data bit in a corresponding bit position of the N-bit shifted input data DI[M+N:N+1] through the first input terminal and a N-th bit MASK1 (N) of the mask MASK1 though a second input terminal to perform the logic AND operation. Accordingly, the AND gates 145 through 149 allows the shifted input data DI[M+N:N+1] to the adders 165 through 169 only when the N-th bit MASK1(N) of the mask MASK1 is set to “1”, while outputting “0” when bit MASK1(N) is set to “0”. Each of the adders 165 through 169 receives a data bit in a corresponding bit position of the (N−1)-th output data DON−1[M:1] through one input terminal and the output of respective AND gate in the (N−1)-th gated addition row through another input terminal to perform Mod-2 addition. The adders 165 through 169 may output the addition results as a N-th output data DON[M:1] of the shift addition array 120. As a result, the N-th output data DON[M:1] is Mod-2 addition of the (N−1)-th output data DON−1[M:1] and the N-bit shifted input data DI[M+N:N+1] in case that the bit MASK1(N) is set to “1”, but is the same as the (N−1)-th output data DON−1[M:1] in case that the bit MASK1(N) is set to “0”. That is, the N-th output data DON[M:1] is Mod-2 addition of the input data DI[M:1] and the data selected by the mask data MASK [N:1] among the shifted data DI[M+1:2] through DI[M+N:N+1].

The following is an example of a Hardware Description Language (HDL) code for defining the shift addition array 120 in generating a detailed circuit diagram using the HDL, e.g., the Verilog HDL or VHDL, for implementing the digital signal processor of the present embodiment into an integrated circuit, and summarily shows the function of the shift addition array 120.

DO1 = MASK1(1) AND { DI(M+1..2) XOR DI(M..1) };
DO2 = MASK1(2) AND { DI(M+2..3) XOR DO1 };
DO3 = MASK1(3) AND { DI(M+3..4) XOR DO2 };
...
DON-1 = MASK1(N−1) AND { DI(M+N−1..N) XOR DON-2 };
DON = MASK1(N) AND { DI(M+N..N+1) XOR DON-1 };

As described above, the mask MASK1 carries out the function of selecting input data words shifted by desired amounts, and the shift addition array 120 can perform Mod-2 additions, in parallel, with respect to the unshifted input data word and all or some of the N shifted input data words. Since the data shift is performed by the simple wiring and the unwanted shifted data are reset to “0” by the AND gates based on the mask MASK1, unnecessary power consumption for toggling the outputs of the AND gates and the adders is minimized. Also, the mask MASK1 functions as selection signals in the switching unit 124 which enables the switching unit 124 selectively stores, into the register bank 110, only the valid outputs among the N output data of the shift addition array 120. That is, the switching unit 124 stores only the valid output data designated by the mask MASK1 to the registers of the register bank 110 or the bit-loadable register 112.

Such a manipulation of performing Mod-2 additions, in parallel, with respect to the unshifted input data word and all or some of the shifted input data words and storing the addition result in the register bank 110 can be completed in a single clock cycle, and facilitates various kinds of operations according to the mask MASK1. The number of bits of the mask MASK1, N, and that of the mask MASK2, M, can be chosen arbitrarily. The larger the numbers, M and N, are, the more input data bits can be processed simultaneously, which enhances the processing speed of the bit manipulations such as the scrambling, the convolutional encoding, and the interleaving, etc, and diversifies the types of standards that the bit manipulation unit 108 can support. Meanwhile, the number of bits in the mask MASK1, M, might be same as that in the mask MASK2, N, depending on the applications.

On the other hand, in the present embodiment, the shift addition array 120 receives the M+N bits wide input data because the input data is shifted by maximal N bits in obtaining the N-tuple M bits wide output data. However, the meaningful bit width of the actual input data supplied to the shift addition array 120 and the number of the valid output data depends on the specific bit manipulations executed by the shift addition array 120. For example, in case of the convolutional encoding where the input data is not cyclically shifted, M+N bits wide input data is needed for obtaining a valid M bits wide output data, and only the N-th output data DON among the N output data is valid and is stored in the register bank 110. However, in case of the scrambling where the input data is cyclically shifted, the effective output data is K bits wide (where K is the constraint length) and input data shifted by more than K bits are unnecessary, and multiple output data are regarded to be valid and are stored in the register bank 110 for combining the K bits wide data to be used as initial values in the subsequent operation state.

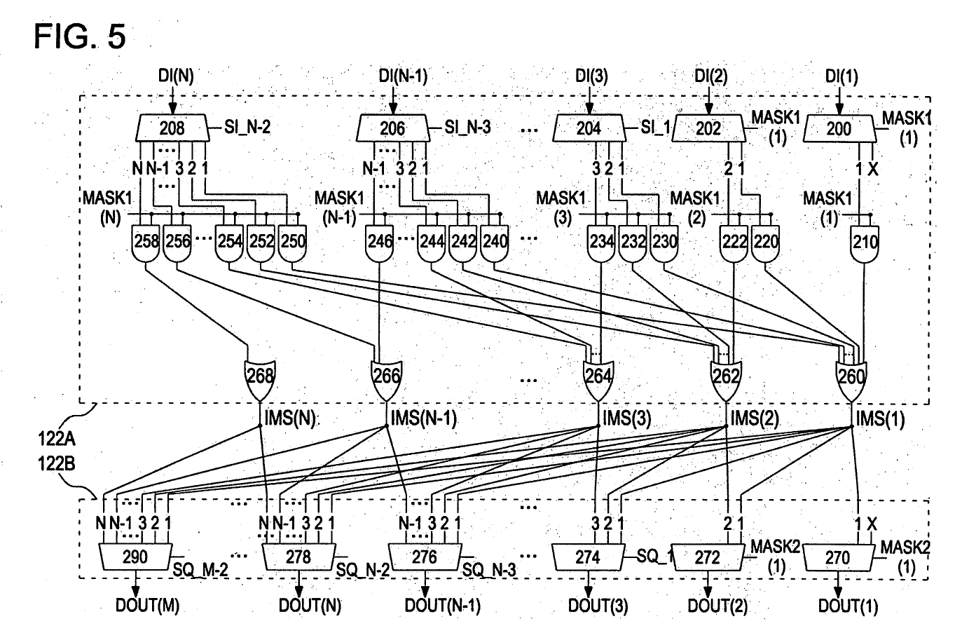

FIG. 5 shows an embodiment of the bit extraction and insertion unit 122 shown in FIG.3 in detail. The bit extraction and insertion unit 122 includes a extraction unit 122A and an insertion unit 122B. In the present embodiment, the extraction unit 122A, which is composed of N demultiplexers 200 through 208, N*(N−1)/2 AND gates 210 through 258, and N OR gates 260 through 268, receives an input data DI of N bits and extracts some bits in the N bits wide input data DI according to the bit setting status of the mask MASK1. The insertion unit 122B, which is composed of M multiplexers 270 through 290, outputs the extracted bits in the bit positions of an output data DOUT of M bits according to the bit setting status of the mask MASK2.

Each of the demultiplexers 200 through 208 has a single input terminal, but the number of the output terminals of the first and second demultiplexers 200 through 208 may be different from one another. For example, in the embodiment shown in the figure, the demultiplexers 200 and 202 have two output terminals, the third demultiplexer 204 has three output terminals, the (N−1)-th demultiplexer 206 has N−1 output terminals, and the N-th demultiplexer 208 has N output terminals. Generally, it can be said that the j-th multiplexer, where j is greater than 1 and less than or equal to N, has j output terminals.

The demultiplexer 200 receives the first bit DI(1), that is, the least significant bit, of the input data DI, and outputs the received data through the second output terminal according to the first bit MASK1(1) of the mask MASK1. The first output terminal of the demultiplexer 200 is not used. The AND gate 210 receives the output signal of the demultiplexer 200 through one input terminal and the first bit MASK1(1) of the mask MASK1 through the other input terminal to perform the logic AND operation. The demultiplexer 202 receives the second bit DI(2) of the input data DI, and outputs the received data through the first or the second output terminal according to the first bit MASK1(1) of the mask MASK1. Each of the AND gates 220 and 222 receives respective one of the output signals of the demultiplexer 202 and the second bit MASK1(2) of the mask MASK1 to perform the logic AND operation. The demultiplexer 204 receives the third bit DI(3) of the input data DI, and outputs the received data through one of the output terminals according to a selection signal SI_1. Each of the AND gates 230 through 234 receives respective one of the output signals of the demultiplexer 204 and the third bit MASK1(3) of the mask MASK1 to perform the logic AND operation.

Similarly, the demultiplexer 206 receives the (N−1)-th bit DI(N−1) of the input data DI, and outputs the received data through one of the output terminals according to a selection signal SI_N−1. Each of the AND gates 240 through 246 receives respective one of the output signals of the demultiplexer 206 and the (N−1)-th bit MASK1(N−1) of the mask MASK1 to perform the logic AND operation. The demultiplexer 208 receives the N-th bit DI(N) of the input data DI, and outputs the received data through one of the output terminals according to a selection signal SI_N. Each of the AND gates 250 through 258 receives respective one of the output signals of the demultiplexer 208 and the N-th bit MASK1(N) of the mask MASK1 to perform the logic AND operation.

The OR gate 260, which has N input terminals, receives the output of the AND gate 210 and outputs of the AND gates 220, 230, 240, and 250 which are connected to the first output terminals of respective demultiplexers 200 through 208 to perform logic OR operation. The OR gate 262, which has N−1 input terminals, receives the outputs of the AND gates 222, 232, 242, and 252 which are connected to the second output terminals of respective demultiplexers 202 through 208 to perform logic OR operation. The OR gate 264, which has N−2 input terminals, receives the outputs of the AND gates 234, 244, and 254 which are connected to the third output terminals of respective demultiplexers 204 through 208 to perform logic OR operation. Similarly, the OR gate 266, which has two input terminals, receives the outputs of the AND gates 246 and 256 which are connected to the (N−1)-th output terminals of respective demultiplexers 206 and 208 to perform logic OR operation. The OR gate 268 receives the output of the AND gates 258 connected to the N-th output terminal of the demultiplexer 208 to perform logic OR operation with the logic “0”. Here, it is preferable to omit the OR gate 268 by replacing with a simple wiring. The output signals of the OR gates 260 through 268, which are provided to the multiplexers 270 through 290, are referred to as intermediate signals IMS(1)-IMS(N) hereinbelow.

The first multiplexer 270 has at least one input terminal, the second multiplexer 272 has two input terminals, the third multiplexer 274 has three input terminals, and the (N−1)-th multiplexer 276 has N−1 input terminals. Meanwhile, all the N-th through M-th multiplexers 278-290 have N input terminals. All the first input terminals of the multiplexers 270 through 290 are connected to the output terminal of the OR gate 260 to receive the first intermediate signal IMS(1). All the second input terminals of the multiplexers 272 through 290 are connected to the output terminal of the OR gate 262 to receive the second intermediate signal IMS(2). All the third input terminals of the multiplexers 274 through 290 are connected to the output terminal of the OR gate 264 to receive the third intermediate signal IMS(3). All the (N−1)-th input terminals of the multiplexers 276 through 290 are connected to the output terminal of the OR gate 266 to receive the (N−1)-th intermediate signal IMS(N−1). Meanwhile, all the N-th input terminals of the multiplexers 278 through 290 are connected to the output terminal of the OR gate 268 to receive the N-th intermediate signal IMS(N).

The multiplexer 270 outputs the received signal as the first bit DOUT(1) of the output data according to the first bit MASK2(1) of the mask MASK2. The multiplexer 272 selects one of the received signals to output as the second bit DOUT(2) of the output data according to the first bit MASK2(1) of the mask MASK2. The multiplexer 274 selects one of the received signals to output as the third bit DOUT(3) of the output data according to a selection signal SQ_1. Similarly, the multiplexer 290 selects one of the received signals to output as the M-th bit DOUT(M) of the output data according to a selection signal SQ_M−2.

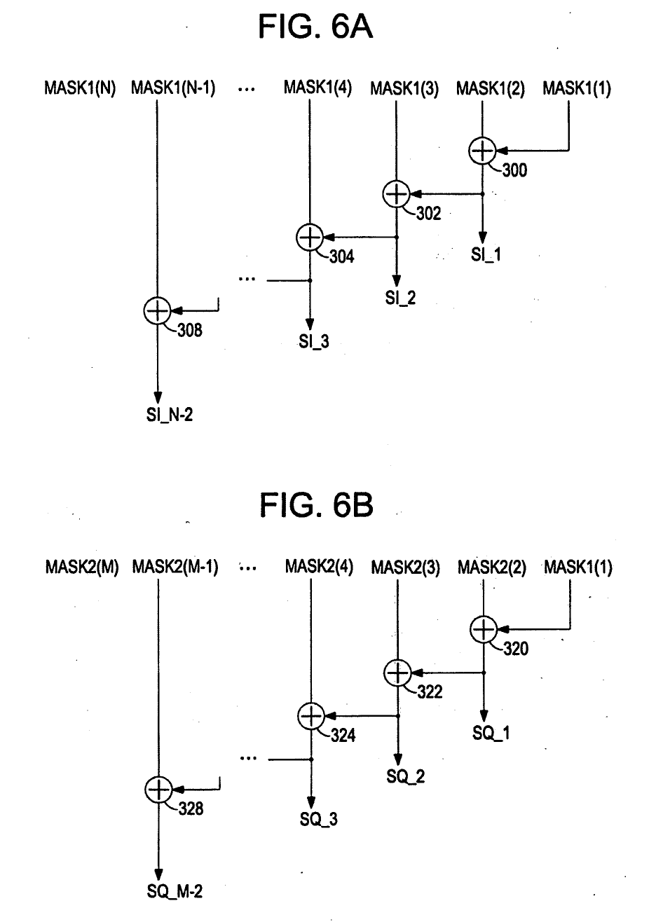

FIGS. 6A and 6B shows the circuit for generating the selection signals SI_1 through SI_N−2 and SQ_1 through SQ_M−2.

Referring to FIG. 6A, the selection signals SI_1 through SI_N−2 are obtained by a cascaded addition of the bits of the mask MASK1. An adder 300 adds the first bit MASK1(1) of the mask MASK1 to the second bit MASK1(2) to output the selection signal SI_1. An adder 302 adds the selection signal SI_1 to the third bit MASK1(3) of the mask MASK1 to output the selection signal SI_2. An adder 304 adds the selection signal SI_2 to the fourth bit MASK1(4) of the mask MASK1 to output the selection signal SI_3. In a similar manner, an adder 308 adds the selection signal SI_N−3 to the (N−1)-th bit MASK1(N−1) of the mask MASK1 to output the selection signal SI_N−2.

Accordingly, the selection signal SI_1 represents one of three values, zero through two, and the demultiplexer 204 shown in FIG. 5 outputs the received data through one of the three output terminals in response to the selection signal SI_1. The selection signal SI_2 represents one of four values, zero through three, and the selection signal SI_3 represents one of five values, zero through four. The selection signal SI_N−2 represents one of N values, zero through N−1, and the demultiplexer 208 outputs the received data through one of the N output terminals in response to the selection signal SI_N−1.

Referring to FIG. 6B, the selection signals SQ_1 through SQ_M−2 are obtained by a cascaded addition of the bits of the mask MASK2. An adder 320 adds the first bit MASK2(1) of the mask MASK2 to the second bit MASK2(2) to output the selection signal SQ_1. An adder 322 adds the selection signal SQ_1 to the third bit MASK2(3) of the mask MASK2 to output the selection signal SQ_2. An adder 324 adds the selection signal SQ_2 to the fourth bit MASK2(4) of the mask MASK2 to output the selection signal SQ_3. In a similar manner, an adder 328 adds the selection signal SQ_M−3 to the (M−1)-th bit MASK2(M−1) of the mask MASK2 to output the selection signal SQ_M−2.

Accordingly, the selection signal SQ_1 represents one of three values, zero through two, and the multiplexer 274 shown in FIG. 5 selects one of the three received signals in response to the selection signal SQ_1. The selection signal SQ_2 represents one of four values, zero through three, and the selection signal SQ_3 represents one of five values, zero through four. The selection signal SQ_M−2 represents one of M values, zero through M−1, and the multiplexer 290 selects one of the N received signals in response to the selection signal SQ_M−1. Even though the number of events which the selection signal SQ_M−2 apparently represents, M, is different from the number of input terminals of the multiplexer 290, N, there happens no problem since the number of events which the selection signal SQ_M−2 substantially represents a number less than or equal to N.

The following is an example of a HDL code for defining the circuits of FIGS. 6A and 6B in generating a detailed circuit diagram for implementing the digital signal processor of the present embodiment into an integrated circuit, and summarily shows the function of the circuits.

SI_1 = MASK1(1) + MASK1(2);
SI_2 = SI_1 + MASK1(3);
...
SI_N−2 = SI_N−3 + MASK1(N−1);
SQ_1 = MASK2(1) + MASK2(2);
SQ_2 = SQ_1 + MASK2(3);
...
SQ_M−2 = SQ_M−3 + MASK2(M−1);

The following is an example of a HDL code for defining the bit extraction and insertion unit 122 of FIG. 5 in generating a detailed circuit diagram for implementing the digital signal processor of the present embodiment into an integrated circuit.

```
IF MASK1(1)=1 THEN IMS(1)=DI(1);
IF MASK1(2)=1 THEN
    IF MASK1(1)=0 THEN IMS(1)=DI(2);
    ELSEIF MASK1(1)=1 THEN IMS(2)=DI(2);
IF MASK1(3)=1 THEN
    IF SI_1=0 THEN IMS(1)=DI(3);
    ELSEIF SI_1=1 THEN IMS(2)=DI(3);
    ELSEIF SI_1=2 THEN IMS(3)=DI(3);
...
IF MASK1(N)=1 THEN
    IF SI_N−2=0 THEN IMS(1)=DI(N);
    ELSEIF SI_N−2=1 THEN IMS(2)=DI(N);
    ELSEIF SI_N−2=2 THEN IMS(3)=DI(N);
    ...
    ELSEIF SI_N−2=N−1 THEN IMS(N)=DI(N);
IF MASK2(1)=1 THEN DOUT(1)=IMS(1);
IF MASK2(2)=1 THEN
    IF MASK2(1)=0 THEN DOUT(2)=IMS(1);
    ELSEIF MASK2(1)=1 THEN DOUT(2)=IMS(2);
IF MASK2(3)=1 THEN
    IF SQ_1=0 THEN DOUT(3)=IMS(1);
    ELSEIF SQ_1=1 THEN DOUT(3)=IMS(2);
    ELSEIF SQ_1=2 THEN DOUT(3)=IMS(3);
...
IF MASK2(M)=1 THEN
    IF SQ_N−2=0 THEN DOUT(M)=IMS(1);
    ELSEIF SQ_N−2=1 THEN DOUT(M)=IMS(2);
    ELSEIF SQ_N−2=2 THEN DOUT(M)=IMS(3);
    ...
    ELSEIF SQ_N−2=N−1 THEN DOUT(M)=IMS(N);
```

Referring back to FIG. 5, the mask MASK1 carries out the function of selectively extracting some bits of the input data DI[N:1] and transferring to the intermediate signals IMS[N:1]. Here, the input data bits in the bit positions where the corresponding bits in the mask MASK1 are set to “0” are blocked by the AND gates. The input data bits in the bit positions where the corresponding bits in the mask MASK1 are set to “1” are transferred to the intermediate signals IMS[N:1] in the order of filling from the least significant bit to the most significant bit. That is, the input data bit corresponding to the least significant bit position among the bits in the mask MASK1 set to “1” is transferred to the intermediate signals IMS(1), the next input data bit is transferred to the intermediate signals IMS(2), and so on.

The mask MASK2 carries out the function of designating the bit positions of the output data DOUT[M:1] for outputting the intermediate signals IMS[N:1]. That is, the intermediate signals IMS[N:1] are inserted in the bit positions of the output data DOUT[M:1] corresponding to the bits in the mask MASK1 set to “1”. The intermediate signals IMS(1) is transferred to the bit position of the output data corresponding to the least significant bit of the bits in the mask MASK1 set to “1”, the intermediate signals IMS(2) is transferred to the bit position of the output data corresponding to the secondly least significant bit of the bits in the mask MASK1 set to “1”, and so on.

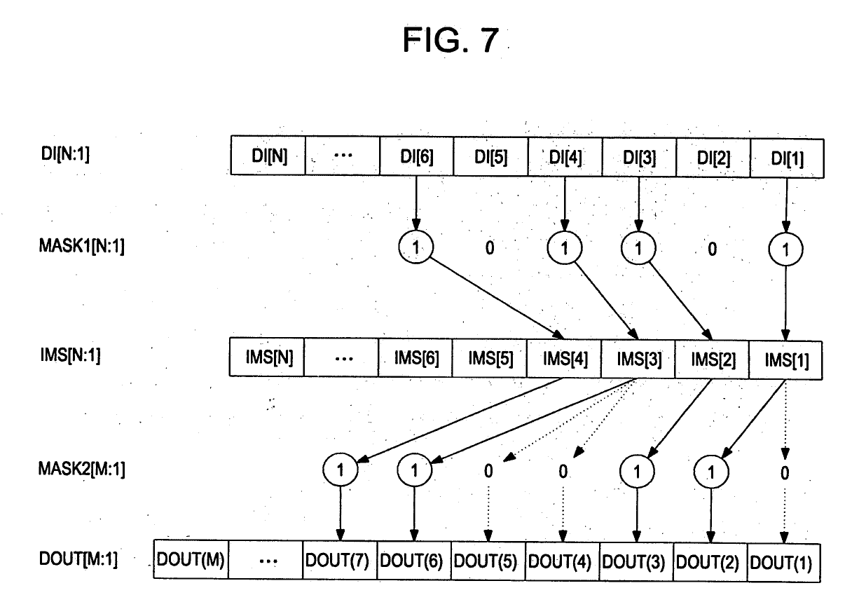

FIG. 7 exemplifies the operation of the bit extraction and insertion unit 122. Here, it is assumed that the least significant six bits of the mask MASK1 are “101101” and the least significant seven bits of the mask MASK2 are “1100110”.

Since the first bit MASK1(1) of the mask MASK1 is “1”, the demultiplexer 200 outputs the first bit DI(1) of the input data through the second output terminal, and the input data bit DI(1) is transferred to the intermediate signal IMS(1) via the AND gate 210 and the OR gate 260. The demultiplexer 202 outputs the second bit DI(2) of the input data through the second output terminal also, but the signal is blocked by the AND gate 222. Since the selection signal SI_1 has a value of “1”, the demultiplexer 204 outputs the third bit DI(3) of the input data through the second output terminal, and the input data bit is transferred to the intermediate signal IMS(2) via the AND gate 232 and the OR gate 262. Since the selection signal SI_2 is “2”, the fourth bit DI(4) of the input data is transferred to the intermediate signal IMS(3) through the third output terminal of a corresponding demultiplexer, an AND gate and an OR gate. Since the fifth bit MASK1(5) of the mask MASK1 is “0”, the fifth bit DI(5) of the input data is blocked by the AND gate in a corresponding signal path. Since the selection signal SI_4 is “3”, the sixth bit DI(6) of the input data is transferred to the intermediate signal IMS(4) through the fourth output terminal of a corresponding demultiplexer, an AND gate and an OR gate. Consequently, only the input data bits in the bit positions where the corresponding bits in the mask MASK1 are set to “1” are transferred to the intermediate signals IMS[N:1] in the order of filling from the least significant bit to the most significant bit.

On the other hand, since the first bit MASK2(1) of the mask MASK2 is “0”, the multiplexer 270 provides no significant output as the first bit DOUT(1) of the output data. The multiplexer 272 outputs the intermediate signal IMS(1) supplied though the first input terminal as the second bit DOUT(2) of the output data. Since the selection signal SQ_1 is “1”, the multiplexer 274 outputs the intermediate signal IMS(2) supplied though the second input terminal as the third bit DOUT(3) of the output data. Since the selection signal SQ_2 is “2”, the fourth multiplexer (not shown in the figure) outputs the intermediate signal IMS(3) supplied though the third input terminal as the fourth bit DOUT(4) of the output data, but the data may be disregarded by the bit-loadable register 112 as described below. Since the selection signal SQ_3 is “2”, the fifth multiplexer (not shown in the figure) outputs the intermediate signal IMS(3) supplied though the third input terminal as the fifth bit DOUT(5) of the output data, but the data may be disregarded by the bit-loadable register 112 also. Since the selection signal SQ_4 is “2”, the sixth multiplexer (not shown in the figure) outputs the intermediate signal IMS(3) supplied though the third input terminal as the sixth bit DOUT(6) of the output data. Since the selection signal SQ_5 is “3”, the seventh multiplexer (not shown in the figure) outputs the intermediate signal IMS(4) supplied through the fourth input terminal as the seventh bit DOUT(7) of the output data. Consequently, the intermediate signal bits IMS[N:1] are transferred to the bit positions of the output data DOUT where the mask MASK2 is set to “1”, and maximum N effective data bits can be output by the bit extraction and insertion unit 122.

As described above, the bit extraction and insertion unit 122 can arbitrarily extract a plurality of bits dispersed or contiguous in the N bits wide input data according to the bit setting status of the mask MASK1 and outputs the extracted bits to arbitrary bit positions in the output data according to the mask MASK2.

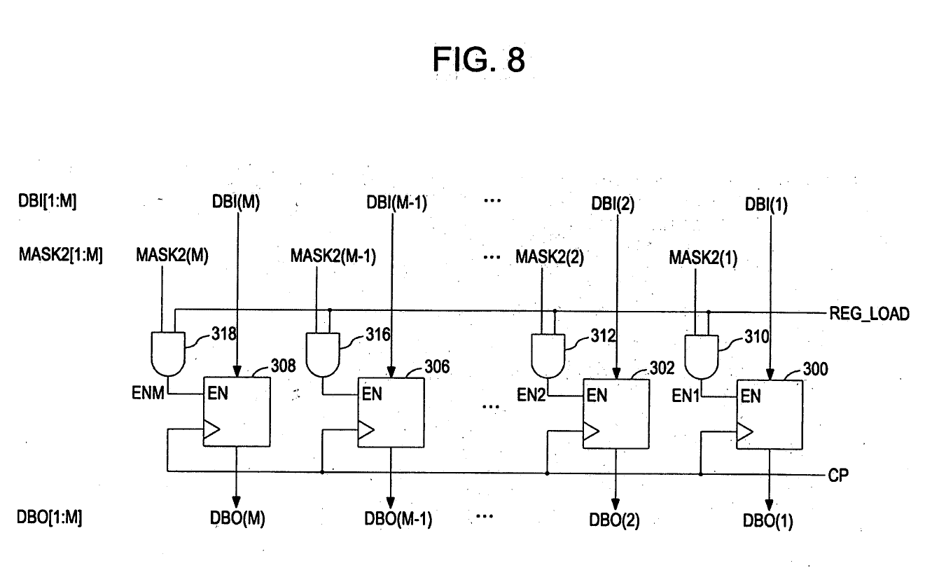

It is preferable that the output data manipulated by the bit extraction and insertion unit 122 is stored in the bit-loadable register 114 shown in FIG. 8. The bit-loadable register 114 includes M flip-flops 300 through 308 each having an enable signal input terminal EN and a clock input terminal, and M AND gates 310 through 318. The bit-loadable register 114 loads, bit by bit, the M bits wide input data DBI[M:1], that is, selectively loads each bit of the M bits wide input data DBI[M:1] according to the bit setting status of the mask MASK2.

The AND gate 310 receives a register load signal REG_LOAD and the first bit MASK2(1) of the mask MASK2 and carries out the logic AND operation to output the operation result as an enable signal EN1. The flip-flop 300 loads the first input data bit DBI(1) in response to the transition of a clock pulse CP only when the enable signal EN1 is activated. Also, the flip-flop 300 can output the stored data as the first output bit DBO(1) regardless that the enable signal EN1 is activated. Thus, the flip-flop 300 loads the first input data bit DBI(1) only when the first bit MASK2(1) of the mask MASK2 is set to “1” and the enable signal EN1 is activated. Contrarily, the flip-flop 300 retains the previously stored data bit when the first bit MASK2(1) of the mask MASK2 is set to “0” or the enable signal EN1 is deactivated. Similarly, the flip-flops 302 through 308 loads the corresponding input data bit only when the corresponding bit of the mask MASK2 is set to “1” and respective enable signal is activated, but retains the previous data bit when the bit in the mask MASK2 is set to “0” or the enable signal EN2-ENM is deactivated.

Accordingly, the register load signal REG_LOAD is activated, the bit-loadable register 114 loads only the input data bits in the bit positions where the corresponding bit in the mask MASK2 is set to “1” while retaining the previously stored data bit in the bit positions where the corresponding bit in the mask MASK2 is set to “0”. For example, if the data stored in the bit-loadable register 114 is provided to the bit extraction and insertion unit 122 shown in FIGS. 3 and 5 and then the manipulated data is loaded bit by bit onto the bit-loadable register 114 under the mask MASK2 which is same as that used in the bit extraction and insertion unit 122, the unwanted manipulation data bits introduced by the bit extraction and insertion unit 122 are discarded and the data bits not manipulated by the bit extraction and insertion unit 122 retain their original state.

The bit manipulation of selecting all or some bits of the input data word according to the bit setting status of the mask MASK1 and storing the selected bits in the bit positions, selected by the mask MASK2, in the bit-loadable register 114 can be completed in a single clock cycle. Thus, using such bit manipulation steps, the operation speed for extracting bits from several data words and combining the extracted bits into a single data word can be enhanced. In particular, the bit-loadable register 114 obviates the use of multiple OR operations for combining the extracted bits, which increases the operation speed further. This efficient operation can be applied in scrambling code generation, convolutional encoding, puncturing, and interleaving, etc.

The operation of the bit manipulation unit 118 shown in FIGS. 3 through 6 will be described hereinbelow.

First, the scrambling can be performed, as follows, utilizing the shift addition array 120 and the bit extraction and insertion unit 122. In the scrambling having the constraint length K and described by the generator polynomial of equation 2, a scrambling code can be obtained by Mod-2 additions of: (K−1)-bit shifted input data, A-bit shifted input data, 1-bit shifted input data, and the original input data.

g(x)=x^{K-1}+x^{A}+x+1 (2)

The data shifts and Mod-2 additions can be carried out by the shift addition array 120. At this time, the bit positions corresponding to the shift amounts in the mask MASK1 are set to “1” while the other bit positions are set to “0”. After the bit manipulation in the shift addition array 120, the number of valid output data bits from each gated addition row providing valid output data is (K−1-shift amount). Thus, the maximal number of output data bits from each gated addition row is K−1, and the valid output data bits from several gated addition rows should be combined into a single word. Such a combining task can be carried out by the bit extraction and insertion unit 122.

The convolutional encoding can also be performed by the shift addition array 120. Assuming that the generator polynomial is described as by equation 3, the convolutional encoding is performed by shifting the input data K−1 bits, A bits, B bits, and C bits, and then carrying out Mod-2 additions of: the (K−1)-bit shifted data, the A-bit shifted data, the B-bit shifted data, the C-bit shifted data, and the original input data. At this time, (K−1)-th, the A-th, the B-th, and C-th bit positions from the least significant bit in the mask MASK1 are set to “1” while the other bit positions are set to “0”. When the data is encoded according to several generator polynomials depending on the code rate, the bit extraction and insertion unit 122 should combine the encoded data in order to maintain the code rate consistently.

g(x)=x^{K-1}+x^{A}+x^{B}+x^{C}+1 (3)

The puncturing or the depuncturing for deleting or inserting some symbols in the input data word, respectively, can be performed by the bit extraction and insertion unit 122. After the input data word is loaded in the bit-loadable register 112, the bit extraction and insertion unit 122 receives the input data word from the bit-loadable register 112, extracts some of the input data bits, and moves the extracted bits to another bit locations. Afterwards, only the valid output data bits are stored again in the bit-loadable register 112.

As mentioned above, the digital signal processor according to the present invention receives a program formed of a sequence of instructions through the program interface 100, stores the program in the program memory 102, and operates according to the instructions after decoding the instructions. In particular, the digital signal processor of the present invention is programmable based on fifty or more reduced instruction sets. A few instructions which reveal the essential aspects of the present invention are presented below. In the descriptions of the instructions, the symbol “>>” denotes the shift-right operation, the symbol “&” represents the bit concatenation, and the symbol “<=” denotes the assignment.

First, the following example shows the syntax of the scrambling instruction. The value or variable name of the mask MASK1 and the value or variable name of the input data word are specified in the instruction syntax.

```
Instruction Syntax:
    SCB MASK1 {MASK1}, SRC {INPUT};
Description:
    REGISTERS (Selected by the mask MASK1) <= SRC
    XOR (SRC >> (Shift amount determined by the Mask 1))
```

The following example shows the syntax of the convolutional encoding instruction. The value or variable name of the mask MASK1 and the values or variable names of two input data words to be concatenated are specified, in the instruction syntax, along with the location of the register or the variable name for storing the codeword.

```
Instruction Syntax:
    CONY MASK1 {MASK1}, SRC1 {INPUT1}, SRC2 {INPUT2},
    DST {Output};
Description:
    DST (Register) <= (SRC1 & SRC2) XOR ((SRC1 & SRC2) >>
    (Shift amount determined by the Mask 1))
```

The following example shows the syntax of the puncturing instruction. The values or variable names of two masks MASK1 and MASK2, and the values or variable names of the input data word are specified in the instruction syntax.

```
Instruction Syntax:
    PUNC MASK1 {MASK1}, MASK2 {MASK2}, SRC {INPUT};
Description:
    Bit loadable register (Bit positions selected by MASK2) <= SRC
    (Bits selected by MASK1)
```

The bit manipulation unit of the present invention can speedily perform the bit manipulations involved in the operations of the scrambling/descrambling, convolutional encoding, puncturing, and interleaving, which are commonly used in various digital communication systems. In particular, the bit manipulation unit is small in its hardware because the shift addition array and the bit extraction and insertion unit are composed of combinational logic gates only, and can perform all operations of one unit step in a single clock cycle.

The following table compares the performance of the programmable processor of the present invention with those of conventional high performance digital signal processors. Even though the conventional processors adopts the VLIW architecture having four shifters and four logical units, the processor of the present invention is found to be more efficient than the conventional processors.

| | | | | | Cycles for |
|---|---|---|---|---|---|
| | | Cycles for | | Cycles for | Convolutional |
| | | Convolutional | | Scrambling | Encoding |
| | | Encoding | Cycles for | (802.11a | (802.11a |
| | | (IS-95 | Block | Standard, | Standard, |
| | Computation | Standard, | Interleaving | data rates of | data rates of |
| Processors | Units | K = 9, R = 1/2) | (16 * 6 bits) | 12 Mps) | 12 Mps) |
| StarCore | 4 Shifters and | 463 | 414 | Unknown | Unknown |
| SC140 | 4 Logic Units | | | | |
| TI | | Unknown | Unknown | 39 × 10⁶ | 77 × 10⁶ |
| 62x | | | | | |
| Present | Bit | 186 | 90 | 20 × 10⁶ | 12 × 10⁶ |
| invention | manipulation | | | | |
| | Unit (118) is | | | | |
| | added. | | | | |

Comparing with the StarCore SC140, the processor of the present invention is faster, by about 2.5 times, in the convolutional encoding of constraint 9 and code rate of 1/2 according to the IS-95 standard., and is faster, by about 4.5 times, in the block interleaving of 16*6 bits. Comparing with the TI 62x, the processor of the present invention is faster, by about 2 times in the scrambling and by about 6 times in the convolutional encoding when the data rate is 12 Mbits/s according to the 802.11a standard.

The bit manipulation circuit of the present invention can be adopted in a programmable processor such as a digital signal processor to improve the performance of the processor. Since the hardware to be added is small in its size and has a structured configuration, such an extension can be implemented easily. The advantage and efficiency of the bit manipulation operations according to the present invention will become more distinct as the data rates are higher. Also, the present invention, which shows more flexibility in the design of the programmable processor than the prior art methodology, can reduce the time for developing the programmable processor and facilitates the real time processing of the data manipulations. Hence, the present invention can be utilized in the next generation communication systems.

Although the present invention has been described in detail above, it should be understood that the foregoing description is illustrative and not restrictive. Those of ordinary skill in the art will appreciate that many obvious modifications can be made to the invention without departing from its spirit or essential characteristics. Accordingly, the scope of the invention should be interpreted in the light of the following appended claims.

What is claimed is:

1. In a programmable processor comprising a register bank for temporarily storing an operand data, a bit manipulation circuit for performing data encoding operation based on data shift and modulo-2 addition, and bit extraction and insertion operation, comprising:
a shift addition array for receiving the operand data, generating a plurality of shifted data being shifted from the operand data by one bit through the bit width of the operand data, carrying out modulo-2 additions in parallel with respect to the operand data and at least some of the plurality of shifted data, and storing the addition result in the register bank; and
a bit extraction and insertion unit for receiving the operand data, extracting a plurality of bits from the operand data, and inserting each of the extracted bits into a predetermined bit position of an operated data to store the operated data in the register bank.

2. The bit manipulation circuit as claimed in claim 1, wherein said register bank comprises:
a bit-loadable register capable of loading data bit by bit,
wherein said bit extraction and insertion unit receives the operand data from said bit-loadable register and provides the operated data to said bit-loadable register,
wherein said bit-loadable register loads the operated data only in the predetermined bit positions.

3. The bit manipulation circuit as claimed in claim 2, wherein said bit extraction and insertion unit comprises:
a bit extraction unit for receiving a first mask having a bit width being the same as the operand data, and extracting only the operand data bits in the bit positions where the corresponding bit in the first mask is set to a first state; and
a bit insertion unit for receiving a second mask having a bit width being the same as the operated data, and inserting the extracted bits into the operated data bits in the bit positions where the corresponding bit in the second mask is set to the first state,
wherein said bit-loadable register loads the operated data only in the bit positions where the corresponding bit in the second mask is set to the first state.

4. The bit manipulation circuit as claimed in claim 3, wherein said shift addition array comprises:
a plurality of gated addition rows cascadingly connected one after the other, each gated addition row receiving a first and a second data, carrying out Mod-2 addition of the first and the second data when a corresponding bit in the first mask is set to the first state, and outputting the first data when the corresponding bit in the first mask is set to the second state,
wherein, in a first gated addition row, the first data is the operand data and the second data is one-bit shifted operand data,
wherein, in a j-th gated addition row (j is greater than or equal to 2), the first data is the output data of the (j−1)-th gated addition row and the second data is (j+1)-bit shifted operand data.

5. The bit manipulation circuit as claimed in claim 4, further comprising:
a first switching unit for reading the operand data from the register bank to provide to said shift addition array; and
a second switching unit for storing the output data of said gated addition rows to the register bank.

6. The bit manipulation circuit as claimed in claim 5, wherein said second switching unit stores the output data of each of said gated addition rows to the register bank only when the corresponding bit in the first mask is set to the first state.

7. A bit extraction and insertion circuit in a programmable processor, comprising:
a bit-loadable register receiving a first mask and loading a received data word bit by bit according to a bit setting status of the first mask; and
a bit extraction and insertion unit receiving the first mask, a second mask, and the data word, for extracting a plurality of bits from the data word according to a bit setting status of the second mask, and inserting each of the extracted bit into a predetermined bit position of an operated data according to the bit setting status of the first mask to output the operated data to said bit-loadable register,
wherein said bit-loadable register loads the operated data bit by bit according to the bit setting status of the first mask.

8. A programmable processor comprising:
a register bank for temporarily storing an operand data;
a computation unit for receiving the operand data and performing arithmetic and logic operations with respect to the operand data to store the operation result to said register bank;
a bit extraction and insertion unit for receiving the operand data, extracting a plurality of bits in bit positions of the operand data specified by a first mask, and inserting each of the extracted bits into a bit position of an operated data specified by a second mask to output the operated data to the register bank; and
means for providing the first and the second masks.

9. The programmable processor as claimed in claim 8, wherein said register bank comprises:
a bit-loadable register capable of loading data bit by bit,
wherein said bit extraction and insertion unit receives the operand data from said bit-loadable register and provides the operated data to said bit-loadable register,
wherein said bit-loadable register loads the operated data only in the bit positions specified by the second mask.

10. The programmable processor as claimed in claim 8, further comprising:
a shift addition array for receiving the operand data, generating a plurality of shifted data being shifted from the operand data by one bit through the bit width of the operand data, carrying out Mod-2 additions in parallel with respect to the operand data and at least some of the plurality of shifted data specified by the first mask, and storing the addition result in the register bank.

11. The programmable processor as claimed in claim 10, wherein said shift addition array comprises:
a plurality of gated addition rows cascadingly connected one after the other, each gated addition row receiving a first and a second data, carrying out Mod-2 addition of the first and the second data when a corresponding bit in the first mask is set to the first state, and outputting the first data when the corresponding bit in the first mask is set to the second state,
wherein, in a first gated addition row, the first data is the operand data and the second data is one-bit shifted operand data,
wherein, in a j-th gated addition row, the first data is the output data of the (j−1)-th gated addition row and the second data is (j+1)-bit shifted operand data.

12. The programmable processor as claimed in claim 11, further comprising:
a first switching unit for reading the operand data from the register bank to provide to said shift addition array; and
a second switching unit for storing the output data of said gated addition rows to the register bank.

13. In a programmable processor comprising a register bank having a plurality of registers each for temporarily storing a data word, a bit manipulation method comprising the steps of:
providing a mask having a predetermined number of bits;
generating the predetermined number of shifted data words being shifted from the data word by one bit through the predetermined number of bits, and sequentially carrying out Mod-2 additions with respect to the data word and at least some of the shifted data words specified by the mask; and
separately storing each of the sequentially generated addition results in respective register in the register bank.

14. In a programmable processor comprising a register bank having a plurality of registers each for temporarily storing a data word, a bit manipulation method comprising the steps of:
providing a mask having a predetermined number of bits;
concatenating two data words stored in the register bank to generate a concatenated word;
generating the predetermined number of shifted words being shifted from the concatenated word by one bit through the predetermined number of bits, and carrying out Mod-2 additions with respect to the concatenated word and at least some of the shifted words specified by the mask; and
storing at least a partial bit stream of the addition result in the register bank.

15. A bit manipulation method in a programmable processor comprising the steps of:
providing a bit-loadable register capable of loading data word bit by bit;
loading the data word in the bit-loadable register and providing a first and a second masks;
extracting at least some bits of the data word according to a bit setting status of the first mask;
generating an operated data word by inserting the extracted bits into predetermined bit positions of the operated data word according to a bit setting status of the second mask;
loading, into the bit-loadable register, only the bits in the operated data word specified by the second mask.
